(19) United States
(12) Patent Application Publication
(10) Pub. No.: US 2011/0291445 A1
(43) Pub. Date: Dec. 1, 2011

(54) FRONT STRUCTURE FOR A MOTOR VEHICLE

(75) Inventors: Hans-Joachim PATSCHICKE, Otterberg (DE); Jens HARTMANN, Floersheim (DE)

(73) Assignee: GM GLOBAL TECHNOLOGY OPERATIONS LLC, Detroit, MI (US)

(21) Appl. No.: 13/116,113

(22) Filed: May 26, 2011

(30) Foreign Application Priority Data
May 26, 2010 (DE) 102010021574.0

(51) Int. Cl. B62D 25/08

(52) U.S. Cl. 296/193.09

(57) ABSTRACT

A front structure for a motor vehicle with an upper and with a lower load path has a modular component. The modular component includes, but is not limited to a cross member for connecting of ends of side members of the lower load path facing in driving direction and a radiator member for holding a radiator of a combustion engine of the motor vehicle. The front structure because of this can be produced particularly cost-effectively and is constructed in a particularly simple manner.

### CROSS-REFERENCE TO RELATED APPLICATION

This application claims priority to German Patent Application No. 102010021574.0, filed May 26, 2010, which is incorporated herein by reference in its entirety.

### TECHNICAL FIELD

The technical field relates to a front structure for a motor vehicle with side members facing in driving direction, with at least one cross member interconnecting the side members, with a radiator member for holding a radiator of the motor vehicle and with a modular component interconnecting the side members.

### BACKGROUND

A front structure is known for example from DE 10 2006 051 785 A1. With this front structure the modular component is unitarily produced with portions of two side members and in the top view configured U-shaped. Various components such as for example the radiator member for holding the radiator are mounted on the modular component. However, disadvantageous with this front structure is that it comprises a great many components to be produced and mounted. But the high number of components results in manufacturing costs of the front structure that are too high.

At least one objective is to provide a front structure of the type mentioned at the outset so that it is constructed in a particularly simply manner and can be cost-effectively produced. In addition, other objectives, desirable features and characteristics will become apparent from the subsequent summary and detailed description, and the appended claims, taken in conjunction with the accompanying drawings and this background.

### SUMMARY

A seem in driving direction front cross member with the radiator member forms the modular component and in that the modular component is arranged in front of the free end of the side member. The modular component comprising the radiator member thus contributes to the torsional stiffness of the front structure. In addition, the modular component is a substantial component for the pedestrian impact protection of the vehicle equipped with a front structure. Obviously, further components of the motor vehicle can be additionally mounted to the modular component. Because of this, the front structure is a particularly simple construction. The modular component additionally makes possible an integration of different functions and thus particularly low manufacturing costs of the front structure.

The modular component for example could be configured U-shaped in the top view and comprise part regions of the side members. However, according to another embodiment, the front structure proves to be particularly simple constructively if the modular component is configured in an elongated fashion and comprises flanges and if the flanges are connected to the free ends of the side members. The connection can be directly made with the face end of the respective side member or to a support tied to the respective side members. Thus, the modular component has no side member portions and can be produced in a particularly simple fashion. A further embodiment is that the front structure because of this is assembled of substantially straight components and thus has a particularly high level of stability.

In order to reduce the weight at the front structure it is a contribution according to another embodiment if the modular component is produced from plastic or a plastic composite material. Furthermore, the modular component can be produced in a particularly cost-effective fashion as a result.

Modern motor vehicles frequently have an upper load path run via wheels of the motor vehicle and a lower load path run at a low height. The modular component could for example interconnect side members of the upper and lower load path. However, this results in a construction of the modular component that is complicated to produce. According to another embodiment, the modular component can be produced particularly simply if vertical supports each connecting a side member of an upper load path with a side member of a lower load path are arranged seen in driving direction behind the modular component. The flanges of the modular component are fastened to the supports. According to another embodiment the modular component contributes to the further increase of the stability if the modular component interconnects the supports.

To further simply the production of the front structure it is a contribution according to another embodiment if the side members are continuously run up to the vertical supports.

The front structure makes possible the use of different materials of the modular component and of the side members, if the modular component is releasably connected to the supports, preferentially screwed. Because of this, the side members and the supports can be produced from steel and the modular component from plastic. The screw connection makes possible a simple repair of the front structure.

Modern motor vehicles mostly have a pedestrian impact protection facing in driving direction and arranged at a low height. This pedestrian impact protection according to an advantageous further development of the invention can be simply mounted to the front structure if the modular component in driving direction in front of the cross member has a cross brace of a pedestrian impact protection. Preferentially, the cross brace and the remaining parts of the modular component are produced unitarily.

To increase the protection of the pedestrian in the event of an impact it is a contribution according to another advantageous further development of the invention if between the cross member and the cross brace a deformable crash box is arranged.

### BRIEF DESCRIPTION OF THE DRAWINGS

The present invention will hereinafter be described in conjunction with the following drawing figures, wherein like numerals denote like elements, and:

FIG. 1 is a motor vehicle with a front structure; and

FIG. 2 is perspectively, the front structure from FIG. 1.

### DETAILED DESCRIPTION

The following detailed description is merely exemplary in nature and is not intended to limit application and uses. Furthermore, there is no intention to be bound by any theory presented in the preceding background or the following detailed description.

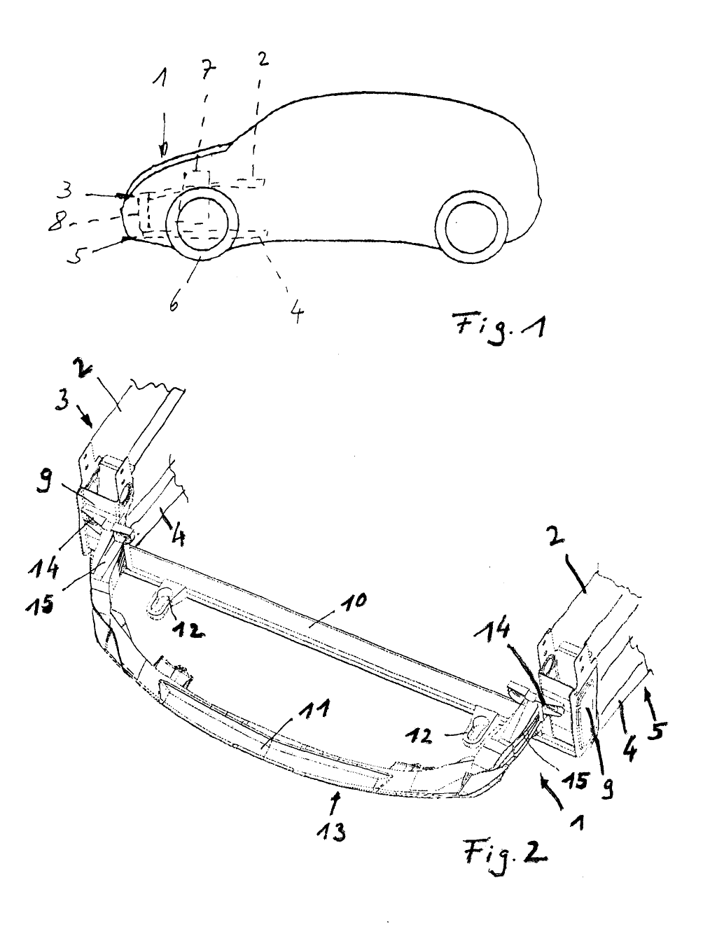

FIG. 1 shows a motor vehicle with a front structure 1 facing in driving direction. The front structure 1 has on each vehicle side an upper load path 3 comprising a side member 2 and a lower load path 5 comprising a side member 4. The side members 2, 4 are run laterally about wheels 6 of the motor vehicle and engage about a combustion engine 7. At the end of the front structure 1 facing in driving direction a radiator 8 of the combustion engine 7 is arranged.

FIG. 2 perspectively shows the front structure 1 from FIG. 1. To explain the drawing, the radiator 8, the combustion engine 7, wheels 6 and outer panels of the motor vehicle are not shown. The side members 2, 4 of the upper and lower load path 3, 5 are continuously run up to vertical supports 9. The supports 9 connect the ends of the side members 2, 4 facing in driving direction. The supports 9 are interconnected via a front cross member 10.

The front cross member 10 is arranged behind a cross brace 11 of a pedestrian impact protection delimiting the front structure 1 and comprises a radiator member 12 for holding the radiator 8 shown in FIG. 1. The front cross member 10 with the radiator member 12 and the cross brace 11 forms a modular component 13, which is screwed or riveted to the supports 9. For fastening to the supports 9 the modular component 13 has a flange 14 at each of its ends. The modular component 13 thus forms a termination of the load path 3, 5. Between the cross brace 11 and the cross member 10 crash boxes 15 are arranged.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A front structure for a motor vehicle, comprising:
side members facing in a driving direction;
a cross member interconnecting the side members;
a radiator member configured to hold a radiator; and
a modular component interconnecting the side members,
wherein a seen in the cross member with the radiator member forms the modular component and the modular component is arranged in front of a free end of the side members.

2. The front structure for a motor vehicle according to claim 1, wherein the modular component is elongated and comprises flanges connected to free ends of the side members.

3. The front structure for a motor vehicle according to claim 1, wherein the modular component is produced from a plastic.

4. The front structure for a motor vehicle according to claim 1, wherein the modular component is produced from a plastic composite material.

5. The front structure for a motor vehicle according to claim 1, further comprising vertical supports interconnecting a side member of an upper load path to a second side member of a lower load path that are arranged seen in the driving direction behind the modular component and the flanges of the modular component are fastened to the supports.

6. The front structure for a motor vehicle according to claim 5, wherein the modular component interconnects the supports.

7. The front structure for a motor vehicle according to claim 6, wherein the side members are continuously run up to the supports in a vertical position.

8. The front structure for a motor vehicle according to claim 5, wherein the modular component is releasably connected to the supports.

9. The front structure for a motor vehicle according to claim 1, wherein the modular component in the driving direction in front of the cross member comprises a cross brace configured for pedestrian impact protection.

10. The front structure for a motor vehicle according to claim 9, further comprising a deformable crash box arranged between the cross member and the cross brace.
